(19) United States
(12) Patent Application Publication
(10) Pub. No.: US 2008/0242744 A1
(43) Pub. Date: Oct. 2, 2008

(54) PROCESS FOR MAKING SILICONE-IN-WATER EMULSIONS

(76) Inventors: KATHLEEN BARNES, Midland, MI (US); WALKER L. ROCHLITZ, Sichuan (CN); ANNE KATJA SHIM, Billerica, MA (US); LINDSEY M. SUHR, Philadelphia, PA (US); RAYMOND LEE TABLER, Midland, MI (US); DAVID SHAWN TASCARELLA, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 12/113,395

(22) Filed: May 1, 2008

Related U.S. Application Data
(63) Continuation-in-part of application No. 10/559,525, filed on Dec. 6, 2005, now Pat. No. 7,385,001.
(60) Provisional application No. 60/489,405, filed on Jul. 23, 2003.
(60) Provisional application No. 60/947,694, filed on Jul. 3, 2007.

(51) Int. Cl. B01F 3/08

(52) U.S. Cl. 516/55

(57) ABSTRACT

A process is disclosed for making a silicone-in-water emulsion by forming a hydrophobic phase containing a silicone component, mixing one or more surfactants with the hydrophobic phase, adding water to the hydrophobic phase and shear mixing in a twin-screw extruder to form a silicone in water emulsion.

### CROSS REFERENCE TO RELATED APPLICATIONS

This application is a Continuation in Part of application Ser. No. 10/559,525, currently pending, which is a U.S. national stage filing under 35 U.S.C. §371 of PCT Application No. PCT/US2004/012001 filed on 19 Apr. 2004, which claims the benefit of U.S. Provisional Patent Application No. 60/489,405 filed 23 Jul. 2003 under 35 U.S.C. § 119 (e). This application further claims the benefit of U.S. Provisional Patent Application No. 60/947,694 filed 3 Jul. 2007 under 35 U.S.C. §119 (e).

### TECHNICAL FIELD

This disclosure relates to a process for making a silicone-in-water emulsion by forming a hydrophobic phase containing a silicone component, mixing one or more surfactants with the hydrophobic phase, adding water to the hydrophobic phase and shear mixing in a twin-screw extruder to form a silicone in water emulsion.

### BACKGROUND

Silicone emulsions are well known in the art. Such silicone emulsions can be made by processes such as (i) mechanical emulsification, (ii) mechanical emulsification by inversion, or by (iii) emulsion polymerization. However, because of the high viscosity of some silicones such as high viscosity fluids, silicone gums, silicone rubbers, silicone elastomers, and silicone resins, their emulsification has for all practical purposes been limited to emulsion polymerization.

However, attempts to use mechanical methods for emulsifying silicone gums, silicone rubbers, silicone elastomers, and silicone resins, have largely been unsuccessful, because it is difficult to incorporate a surfactant or a mixture of surfactants into the silicone gum, silicone rubber, silicone elastomer, or silicone resin. It is also difficult to incorporate water into mixtures containing high viscosity silicones, a surfactant, or a mixture of surfactants, and at the same time impart sufficient shear to cause inversion. In addition, the control of particle size has been limited to processes involving batch-wise mechanical emulsification in the presence of a solvent.

In contrast to the above, the present disclosure provides an inexpensive technique for producing stable emulsions containing silicone gums, silicone rubbers, silicone elastomers, and silicone resins having controlled particle size.

### SUMMARY

This disclosure relates to a method of making a silicone-in-water emulsion comprising the steps of:
(i) forming a hydrophobic phase containing a silicone component selected from a silicone fluid, silicone gum, a silicone rubber, a silicone elastomer, a silicone resin, or a mixture thereof; the silicone in the hydrophobic phase having a viscosity of at least 1,000 mm²/s to 5,000,000,000 mm²/s at 23° C.;
(ii) mixing one or more surfactants with the hydrophobic phase;
(iii) adding water to the hydrophobic phase, the water being added in an amount of 0.5-10 percent by weight based on the weight of the hydrophobic phase;
(iv) shearing the mixture in a twin-screw extruder having a length to diameter (L/D) ratio of at least 12 to form a silicone-in-water emulsion; and
(v) optionally, diluting the silicone-in-water emulsion by the addition of water;
   the method being carried out in the absence of a solvent other than solvents present in the silicone fluid, silicone gum, silicone rubber, silicone elastomer, or silicone resin in (i).

### DETAILED DESCRIPTION

Step (i) in the process of the present disclosure involves forming a hydrophobic phase containing a silicone component selected from a silicone fluid, silicone gum, a silicone rubber, a silicone elastomer, a silicone resin, or a mixture thereof; the silicone in the hydrophobic phase having a viscosity of at least 1,000 mm²/s to 5,000,000,000 mm²/s at 23° C.

As used herein, “silicone” refers to any organopolysiloxane. Organopolysiloxanes are polymers containing siloxane units independently selected from (R₃SiO_{0.5}), (R₂SiO), (RSiO_{1.5}), or (SiO₂) siloxy units, where R may be any monovalent organic group. When R is a methyl group in the (R₃SiO_{0.5}), (R₂SiO), (RSiO_{1.5}), or (SiO₂) siloxy units of an organopolysiloxane, the siloxy units are commonly referred to as M, D, T, and Q units respectively. These siloxy units can be combined in various manners to form cyclic, linear, or branched structures. The chemical and physical properties of the resulting polymeric structures can vary. For example organopolysiloxanes can be volatile or low viscosity fluids, high viscosity fluids/gums, elastomers or rubbers, and resins.

The present method is especially adapted to the emulsification of silicone fluids, gums, silicone rubbers, silicone elastomers, and silicone resins that have viscosities of at least 1,000 centistoke (mm²/s) to 5,000,000,000 centistoke (mm²/s), alternatively at least 10,000 centistoke (mm²/s) to 5,000,000,000 centistoke (mm²/s), alternatively at least 100,000 centistoke (mm²/s) to 5,000,000,000 centistoke (mm²/s), alternatively at least 100,000,000 centistoke (mm²/s) to 5,000,000,000 centistoke (mm²/s) at 23° C. at 23° C.

As noted, this disclosure relates to silicone fluids, gums, silicone rubbers, silicone elastomers, and silicone resins. The silicone selected can be any polydiorganosiloxane fluid or mixtures thereof. If the polyorganosiloxane has a molecular weight equal to or greater than 1000, it can be blended with a volatile methyl siloxane, such as a cyclic methyl siloxane like decamethylcyclopentasiloxane to provide a silicone component having a viscosity of at least 1000 mm/s at 25° C. Typical silicone fluids include polydimethylsiloxanes, such as Dow Corning® 200 fluids (INCI name dimethicone)

The silicone component may also contain an organofunctional silicone such as an aminofunctional polyorganosiloxane, such as those having the formula. R²R₂SiO(R₂ SiO)ₐ(R¹RSiO)_{b}SiR₂R² or R²R₂ SiO(R₂ SiO)ₐ(R¹SiO_{3/2})_{b}SiR₂R² wherein R is a monovalent organic group, R¹ is an aminoalkyl group having its formula selected from the group consisting of —R³NH₂ and —R³NHR⁴NH₂ wherein R³ is a divalent hydrocarbon group having at least 3 carbon atoms and R⁴ is a divalent hydrocarbon group having at least 2 carbon atoms, R² is selected from the group consisting of R, R¹, and —OH, the subscript “a” has a value of 0 to 2000, and b has a value of from greater than zero to 200. The monovalent R groups are exemplified by alkyl groups such as the methyl, ethyl, propyl, butyl, amyl, and hexyl, alkenyl groups such as the vinyl, allyl, and hexenyl, cycloalkyl groups such as the cyclobutyl and cyclohexyl, aryl groups such as the phenyl and naphthyl, aralkyl groups such as the benzyl and 2-phenylethyl, alkaryl groups such as the tolyl, and xylyl, halohydrocarbon groups such as 3-chloropropyl, 4-bromobutyl, 3,3,3-trifluoropropyl, chlorocyclohexyl, bromophenyl, and chlorophenyl. Typically R is a monovalent hydrocarbon group having from 1 to 6 carbon atoms, such as methyl, phenyl, and vinyl. The group R³ is typically an alkylene group having from 3 to 20 carbon atoms. Alternatively R³ is selected from the group consisting of propylene, —CH₂ CHCH₃—, butylene, —CH₂ CH(CH₃)CH₂—, pentamethylene, hexamethylene, 3-ethyl-hexamethylene, octamethylene, and decamethylene. The group R⁴ may be an alkylene group having from 2 to 20 carbon atoms. Alternatively, R⁴ is selected from the group consisting of ethylene, propylene, —CH₂ CHCH₃—, butylene, —CH₂ CH(CH₃)CH₂—, pentamethylene, hexamethylene, 3-ethyl-hexamethylene, octamethylene, and decamethylene. R¹ may be selected from the group consisting of —CH₂ CH₂ CH₂NHCH₂CH₂ NH₂ and —CH₂ CH(CH₃)CH₂NHCH₂ CH₂NH₂. Although the group R² can be selected from the group consisting of R, R¹, and —OH, typically R² is methyl or —OH. The polyorganosiloxanes may have from 0.1 to 15 molar percent of the above described amino groups, alternatively from 0.2 to 10 molar percent of the above described amino groups. The aminofunctional polyorganosiloxanes useful in this disclosure can be prepared by procedures well known in the art. Many of these polyorganosiloxanes are available commercially.

For purposes of this disclosure, the terms silicone rubber and silicone elastomer are considered synonymous, at least to the extent that both silicones are capable of elongation and recovery. Silicone gums in contrast are capable of being stretched, but they do not generally snap back. Silicone gums are the high molecular weight generally linear polydiorganosiloxanes that can be converted from their highly viscous plastic state into a predominately elastic state by crosslinking. Silicone gums are often used as one of the main components in the preparation of silicone elastomers and silicone rubbers.

For purposes of this disclosure therefore, silicone gum can be considered to include compositions of the type described in U.S. Pat. No. 3,692,737 (Sep. 19, 1972), U.S. Pat. No. 4,152,416 (May 1, 1979), U.S. Pat. No. 4,885,129 (Aug. 8, 1989), and U.S. Pat. No. 5,057,240 (Oct. 15, 1991), to which the interested reader is referred.

Silicone ribbers and silicone elastomers can be considered to include compositions of the type described in U.S. Pat. No. 4,882,377 (Nov. 21, 1989), U.S. Pat. No. 5,654,362 (Aug. 5, 1997), U.S. Pat. No. 5,994,459 (Nov. 30, 1999), and U.S. Pat. No. 6,015,858 (Jan. 18, 2000).

Silicone resins can be considered to include compositions of the type described in U.S. Pat. No. 2,676,182 (Apr. 20, 1954), U.S. Pat. No. 4,310,678 (Jan. 12, 1982), U.S. Pat. No. 4,423,095 (Dec. 27, 1983), and U.S. Pat. No. 5,356,585 (Oct. 18, 1994), to which the interested reader is referred, as well as compositions described in more detail below.

The acronym MQ as it relates to silicone resins is derived from the symbols M, D, T, and Q each of which represent a functionality of different types of structural units which may be present in silicones containing siloxane units joined by ≡Si—O—Si≡ bonds. The monofunctional (M) unit represents (CH₃)₃SiO_{1/2} and the difunctional (D) unit represents (CH₃)₂SiO_{2/2}. The trifunctional (T) unit represents CH₃SiO_{3/2} and results in the formation of branched linear siloxanes. The tetrafunctional (Q) unit represents SiO_{4/2} which results in the formation of crosslinked and resinous silicone compositions. Hence, MQ is used when the siloxane contains all monofunctional M and tetrafunctional Q units, or at least a high percentage of M and Q units such as to render the silicone resinous.

Silicone resins useful herein are non-linear siloxane resins having a glass transition temperature (Tg) above 0° C. Glass transition temperature is the temperature at which an amorphous material such as a higher silicone polymer changes from a brittle vitreous state to a plastic state. The silicone resin generally has the formula R′ₐSiO_{(4-a)/2} wherein R′ is a monovalent hydrocarbon group with 1-6 carbon atoms or a functionally substituted hydrocarbon group with 1-6 carbon atoms, and a has an average value of 1-1.8. The silicone resin will alternatively consist of monofunctional (M) units R″₃SiO_{1/2} and tetrafunctional (Q) units SiO_{4/2}, in which R″ is the monovalent hydrocarbon group having 1-6 carbon atoms, alternatively the methyl group. Typically, the number ratio of M groups to Q groups will be in the range of 0.5:1 to 1.2:1, so as to provide an equivalent wherein a in the formula R′ₐSiO_{(4-a)/2} has an average value of 1.0-1.63. Typically, the number ratio is 0.6:1 to 0.9:1. Most preferred are silicone MQ resins in which the number of Q units per molecule is higher than 1, alternatively higher than 5.

The silicone resin may also contain 1-5 percent by weight of silicon-bonded hydroxyl groups such as a dimethylhydroxysiloxy unit (HO)(CH₃)₂SiO_{1/2}. If desired, the silicone resin may contain minor amounts of difunctional (D) units and/or trifunctional (T) units. Typically, the silicone resins have a viscosity of at least 100,000,000 (100 million) centistoke (mm²/s) and a softening temperature of less than about 200° C. The silicone resin may consist of (i) silicone resins of the type MₓQ_{y} where x and y have values such that the silicone resin contains at least more than 5 Q units per molecule; (ii) silicone resins of the type MₓT_{y} where x and y have values such that the silicone resin contains at least more than 5 T units per molecule; and (iii) silicone resins of the type MₓD_{y}TₚQ_{q} where x, y, p, and q have values such that the sum of Q and T units is at least more than 5 units per molecule, and the number of D units varies from 0-100.

The silicone component may also be a silicone oil (as described above) in combination with other organopolysiloxanes, such as resins or elastomers. Silicone elastomers have been used extensively in personal care applications for their unique silky and powdery sensory profile. Most of these elastomers can gel volatile silicones fluids as well as low polarity organic solvents such as isododecane. Representative examples of such silicone elastomers are taught in U.S. Pat. No. 5,880,210, and U.S. Pat. No. 5,760,116, both incorporated for their teaching of suitable silicone elastomer compositions that may be used as component B) in the present invention. To improve compatibilities of silicone elastomers with various personal care ingredients, alkyls, polyether, amines or other organofunctional groups have been grafted onto the silicone elastomer backbone. Representative of such organofunctional silicone elastomers are taught in U.S. Pat. No. 5,811,487, U.S. Pat. No. 5,880,210, U.S. Pat. No. 6,200,581, U.S. Pat. No. 5,236,986, U.S. Pat. No. 6,331,604 U.S. Pat. No. 6,262,170, U.S. Pat. No. 6,531,540, and U.S. Pat. No. 6,365,670, which are incorporated by reference for teaching of organofunctional silicone elastomers suitable as component B) in the present invention.

If a single silicone component is used, it alone may be considered as the hydrophobic phase. If more than one silicone component is used, they may be mixed using any known mixing techniques to form the hydrophobic phase. Typically, the mixing is conducted in the same twin screw extruder, as used in step iv) of the present method, where the formation of the hydrophobic phase is performed by feeding the various silicone components at the front end of the twin screw extruder.

Step ii) involves the addition of a surfactant to the hydrophobic phase formed in step i). The surfactant may be an anionic surfactant, cationic surfactant, nonionic surfactant, amphoteric surfactant, or a mixture of surfactants. Nonionic surfactants and anionic surfactants are preferred, and most preferred are mixtures containing an anionic and a nonionic surfactant, or a mixtures containing two nonionic surfactants. When mixtures containing nonionic surfactants are used, one nonionic surfactant should have a low Hydrophile-Lipophile Balance (HLB) and the other nonionic surfactant should have a high HLB, such that the two nonionic surfactants have a combined HLB of 11-15, alternatively a combined HLB of 12.5-14.5.

Representative examples of suitable anionic surfactants include alkali metal soaps of higher fatty acids, alkylaryl sulphonates such as sodium dodecyl benzene sulphonate, long chain fatty alcohol sulphates, olefin sulphates and olefin sulphonates, sulphated monoglycerides, sulphated esters, sulphonated ethoxylated alcohols, sulphosuccinates, alkane sulphonates, phosphate esters, alkyl isethionates, alkyl taurates, and alkyl sarcosinates. One example of a preferred anionic surfactant is sold commercially under the name Bio-Soft N-300. It is a triethanolamine linear alkylate sulphonate composition marketed by the Stephan Company, Northfield, Ill.

Representative examples of suitable cationic surfactants include alkylamine salts, quaternary ammonium salts, sulphonium salts, and phosphonium salts. Representative examples of suitable nonionic surfactants include condensates of ethylene oxide with long chain fatty alcohols or fatty acids such as a C₁₂₋₁₆ alcohol, condensates of ethylene oxide with an amine or an amide, condensation products of ethylene and propylene oxide, esters of glycerol, sucrose, sorbitol, fatty acid alkylol amides, sucrose esters, fluoro-surfactants, and fatty amine oxides. Representative examples of suitable amphoteric surfactants include imidazoline compounds, alkylaminoacid salts, and betaines.

Representative examples of suitable commercially available nonionic surfactants include polyoxyethylene fatty alcohols sold under the tradename BRIJ by Uniqema (ICI Surfactants), Wilmington, Del. Some examples are BRIJ 35 Liquid, an ethoxylated alcohol known as polyoxyethylene (23) lauryl ether, and BRIJ 30, another ethoxylated alcohol known as polyoxyethylene (4) lauryl ether. Some additional nonionic surfactants include ethoxylated alcohols sold under the trademark TERGITOL® by The Dow Chemical Company, Midland, Mich. Some example are TERGITOL® TMN-6, an ethoxylated alcohol known as ethoxylated trimethylnonanol; and various of the ethoxylated alcohols, i.e., C₁₂-C₁₄ secondary alcohol ethoxylates, sold under the trademarks TERGITOL® 15-S-5, TERGITOL® 15-S-12, TERGITOL® 15-S-15, and TERGITOL® 15-S-40. Surfactants containing silicon atoms can also be used.

The amount of surfactant added in step ii) may vary, but typically ranges from 0.5 to 20 weight percent of the total emulsion composition, alternatively, from 1.0 to 15 weight percent.

Step iii) of the present disclosure involves adding water to the hydrophobic phase, the water being added in an amount of 0.5-10 percent by weight based on the weight of the hydrophobic phase. Generally, the amount of water required in step (iii) is 0.5-10 percent by weight based on the weight of the silicone present in the hydrophobic phase. Typically, the amount of water will be about 1-5 percent by weight based on the weight of the silicone present in the hydrophobic phase. While the water can be added in 2-4 portions, addition of water in a single portion is typical. The initial addition of water can include the surfactant of step ii) and/or the initial water may be inherent to the surfactant composition. Typically, the water and surfactant are added simultaneously in a zone of the twin screw extruder that follows the formation of the hydrophobic phase of step i). A mixture forms in step iii). This mixture may be either a water continuous or silicone continuous emulsion.

Step iv) of the present method involves shearing the mixture from step iii) in a twin-screw extruder having a length to diameter (L/D) ratio of at least 12. In one embodiment, the mixture may have a silicone continuous phase. Although not wishing to be bound by any theory, the present inventors believe step iv) effects a phase inversion when the mixture is a silicone continuous emulsion. Phase inversions generally occurs when the continuous phase of a dispersion becomes the dispersed phase, or vice versa.

Shear mixing in a twin-screw extruder transforms the mixture of step (iii) into a silicone in water emulsion. The twin-screw extruder should have a length to diameter (L/D) ratio of at least 12, alternatively at least 30, or alternatively a L/D ratio of 30-60. If desired, inversion can also be induced using a kneader extruder having a double-arm mixer with an extrusion screw, provided the kneader extruder is capable of functioning with the same efficiency as a twin-screw extruder. The emulsion can contain other additives such as biocides, thickeners, and freeze-thaw stabilizer, in forming the final composition. The particle diameter of the silicone in the emulsions will typically be in a range of about 0.1 to 70.0 μm (micrometer), depending on the amount and characteristics of the surfactant, the initial water amount and the silicone used in the preparation.

It is expected that the method of the disclosure is capable of forming silicone in water emulsions of silicone gums, silicone rubbers, silicone elastomers, silicone resins, and mixtures thereof, in which the silicone has a viscosity of at least 100,000,000 centistoke (mm²/s) to 5,000,000,000 centistoke (mm²/s). Typically, the silicone component(s) should have a viscosity of at least 200,000,000 (200 million) centistoke (mm²/s) to 2,000,000,000 centistoke (mm²/s) at 25° C. It is also expected that the method can be carried out without adding a solvent other than solvents present in the silicone fluid, gum, silicone rubber, silicone elastomer, or silicone resin being emulsified. The emulsification process of the allows active ingredients to be incorporated in the water or the oil phase without hindrance.

Silicone O/W emulsions according to the disclosure are capable of delivering performance properties such as controlled tack and lubrication, and assist in film formation. They can be used in coating applications, household, cosmetic and personal care applications, to provide greater durability, protective qualities, water resistance, and barrier properties. Silicone O/W emulsions for personal care products are capable of providing good aesthetics. They are also useful in products intended for the paper and medical industry. Since silicone O/W emulsions are easier to handle than high viscosity silicones, they facilitate mixing with other emulsions or water-soluble ingredients.

The following examples illustrate the disclosure in more detail. In the examples, the twin-screw extruder had a construction similar to the twin-screw extruder shown in U.S. Pat. No. 5,354,804 (Oct. 11, 1994), to which the interested reader is referred. It had a length of 56 inches (1,400 millimeter), and it contained a pair of screws each having a diameter of about one inch (25 millimeter). However, any twin-screw extruder known in the art is suitable for carrying out the process. For example, the twin-screw extruder can be counter-rotating or co-rotating. It may be equipped with conical twin screws or parallel twin screws. The barrels of the twin-screw extruder may be divided into a number of zones and equipped with metering equipment for introducing materials along the length of the barrel.

### EXAMPLES

These examples are intended to illustrate the invention to one of ordinary skill in the art and should not be interpreted as limiting the scope of the invention set forth in the claims. All measurements and experiments were conducted at 23° C., unless indicated otherwise.

### Example 1

### Emulsions Containing a Silicone Gum

A silicone gum having a viscosity of about 100,000,000 centistoke (mm²/s) was emulsified by pumping the high viscosity silicone gum into a twin-screw extruder. The silicone gum was a dimethylvinylsiloxy terminated polydimethylsiloxane containing about 0.14 percent of phenylmethylsiloxane units. It exhibited a plasticity number of about 55-65 mils, based on the test protocol described in the American Society for Testing and Materials (ASTM) Test Procedure D-926. Tergitol 15-S-5 and Tergitol 15-S-40 nonionic surfactants were added to the silicone gum and mixed. A small amount of water (Water 1) was added to this premix, and the components in the premix were allowed to mix until inversion had occurred and an appropriate particle size had been obtained. The solids content of the resulting ultra-high solids silicone O/W emulsion was adjusted by diluting it with water (Water 2) at the outlet end of the twin-screw extruder. The process parameters are shown in Table 1. Reference to Section Numbers in Table 1 refers to points of addition along the length of the barrel of the twin-screw extruder, where it was equipped with inlets enabling materials to be introduced. The sections are further identified by distances in millimeter from the inlet end of the twin-screw extruder. Water 1 in Run 2 (indicated by an asterisk) was introduced in Section 4 at 350 mm, rather than at Section 3.

TABLE 1

| Component | Point of Addition | Run 1 | Run 2 |
|---|---|---|---|
| Silicone Gum, g/min | Section 1-50 mm | 150 | 250 |
| Tergitol 15-S-40, g/min, | Section 2-150 mm | 6.0 | 11.2 |
| nonionic | | | |
| Tergitol 15-S-5, g/min, | Section 2-150 mm | 2.0 | 3.84 |
| nonionic | | | |
| Water 1, g/min | Section 3-250 mm | 3.8 | 12.4* |
| Water 2, g/min | Section 10-950 mm | 18.8 | 26.3 |
| Total Amount, g/min | | 180.6 | 303.7 |
| Water Rate 1, Wt. % H₂O/Wt. | | 2.4 | 4.7 |
| % Premix | | | |
| Water Rate 2, Wt. % H₂O/Wt. | | 11.9 | 9.9 |
| % Premix | | | |
| Screw Speed, rpm | | 608 | 198 |
| Weight Percent Solids | | 87.0 | 87.3 |
| Particle Size, μm | | 23.4 | 27.9 |
| (micrometer) | | | |

### Example 2

### Emulsions Containing a Silicone Resin

A silicone resin with a viscosity of about one billion centistoke (mm²/s), i.e., 1,000,000,000 centistoke (mm²/s), was emulsified by pumping the high viscosity silicone resin into a twin-screw extruder. The silicone resin was in the form of a 70 weight percent xylene solution of a siloxane resin copolymer consisting essentially of monofunctional (CH₃)₃SiO_{1/2} M units and tetrafunctional SiO_{4/2} Q units. The MQ units were present in the silicone resin in a molar ratio of approximately 0.75:1. The silicone resin contained about 2.4 to 2.9 weight percent of hydroxyl functionality based on the weight of solids. This was determined by Fourier Transform Infrared Spectroscopy (FTIR) analysis according to the test protocol described in the American Society for Testing and Materials (ASTM) Test Procedure E-168. The twin-screw extruder was heated to 60° C. Brij 30 a nonionic surfactant and Bio-Soft N-300 an anionic surfactant were added to the silicone resin and mixed. A small amount of water (Water 1) was added to this premix, and the premix was allowed to mix until inversion had occurred and an appropriate particle size had been obtained. The solids content of the resulting ultra-high solids silicone O/W emulsion was adjusted by diluting it with water (Water 2) at the outlet end of the extruder. The process parameters are shown in Table 2. Reference to Section Numbers in Table 2 refers to points of addition along the length of the barrel of the twin-screw extruder where it was equipped with inlets enabling materials to be introduced.

TABLE 2

| Component | Point of Addition | Run 1 | Run 2 |
|---|---|---|---|
| Silicone Resin, g/min | Section 1-50 mm | 103.4 | 102.4 |
| Brij 30, g/min, nonionic | Section 2-150 mm | 6.8 | 4.8 |
| Bio-Soft N-300, g/min, | Section 3-250 mm | 6.0 | 4.3 |
| anionic | | | |
| Water 1, g/min | Section 4-350 mm | 5.0 | 5.0 |
| Water 2, g/min | Section 12-1150 mm | 19.6 | 19.6 |
| Total Amount, g/min | | 140.8 | 136.1 |
| Water Rate 1, Wt. % H₂O/Wt. | | 4.3 | 4.5 |
| % Premix | | | |
| Water Rate 2, Wt. % H₂O/Wt. | | 16.9 | 17.6 |
| % Premix | | | |
| Screw Speed, rpm | | 317 | 317 |
| Weight Percent Solids | | 82.6 | 81.9 |
| Particle Size, μm | | 0.34 | 0.36 |
| (micrometer) | | | |

### Example 3

### Emulsions Containing a Silicone Elastomer

A silicone elastomer prepared by the method described in U.S. Pat. No. 5,654,362 (Aug. 5, 1997) was emulsified by pumping the silicone elastomer into a twin-screw extruder. The twin-screw extruder was heated to 30° C. Tergitol 15-S-12 a nonionic surfactant was added to the silicone elastomer and mixed. A small amount of water (Water 1) was added to this premix, and the premix was allowed to mix until inversion had occurred and an appropriate particle size had been obtained. The solids content of the resulting silicone O/W emulsion was adjusted by diluting it with water (Water 2) at the outlet end of the twin-screw extruder. The process parameters are shown in Table 3. Reference to Section Numbers in Table 3 refers to points of addition along the length of the barrel of the twin-screw extruder where it was equipped with inlets enabling materials to be introduced.

TABLE 3

| Component | Point of Addition | Run 1 | Run 2 |
|---|---|---|---|
| Silicone Elastomer, g/min | Section 1-50 mm | 218.0 | 350.0 |
| Tergitol 15-S-12, g/min, | Section 2-150 mm | 5.4 | 8.2 |
| nonionic | | | |
| Water 1, g/min | Section 3-250 mm | 3.7 | 4.0 |
| Water 2, g/min | Section 12-1150 mm | 19.6 | 43.8 |
| Total Amount, g/min | | 246.7 | 406.0 |
| Water Rate 1, Wt. % H₂O/Wt. | | 1.7 | 1.12 |
| % Premix | | | |
| Water Rate 2, Wt. % H₂O/Wt. | | 8.8 | 12.2 |
| % Premix | | | |
| Screw Speed, rpm | | 1200 | 1200 |
| Weight Percent Solids | | 90.6 | 88.2 |
| Particle Size, μm | | 17.4 | 23.7 |
| (micrometer) | | | |

### Example 4

### Emulsification of Moderate Viscosity Oil

A polydimethylsiloxane fluid of viscosity 100,000 cSt, two nonionic surfactants and water were fed into a twin screw extruder in the ratios prescribed in the table below.

| Material | % |
|---|---|
| 100,000 cSt silicone fluid | 88.6 |
| Brij 35L | 5.2 |
| Brij 30 | 3.9 |
| Water | 2.3 |
| | 100 |

The resulting particle size is D(v, 05.)=0.37 μm, D(v, 0.9)=0.58 μm. Variations in the weight percent of the components, the order and placement of each raw material addition and the RPM of the extruder screw enables changes in the particle size. For formulation adjustments in the range of those shown in the table below under various process conditions, the particle size minimum is D(v, 0.5)=0.35 μm, D(v, 0.9)=0.53 μm and maximum is D(v, 0.5)=1.8 μm, D(v, 0.9)=5.5 μm.

| | Minimum | Maximum |
|---|---|---|
| Materials | % | % |
| 100,000 cSt silicone fluid | 88 | 95 |
| Brij 35L | 0 | 6 |
| Brij 30 | 0 | 4 |
| Water | 0 | 12 |

After formation of this thick phase emulsion, additional products may be added to the product such as dilution water, preservative, thickener, pH adjustment and additional surfactants.

### Example 5

### Emulsification of a Gum Blended with Fluids

A hydroxy-terminated dimethyl siloxane gum of plasticity 55-65 mils, a hydroxy-terminated dimethyl siloxane fluid of viscosity 2000 cSt., a trimethylsiloxy-terminated dimethyl siloxane of viscosity 700 cSt and a dimethyl siloxane amino fluid (hydrophilic softener) at 3000 cSt. were fed into the twin screw extruder along with 2 non-ionic surfactants and water in the ratios shown in the table below.

| Material | % |
|---|---|
| Si Gum | 31.5 |
| Fluid 1 (2000 cSt) | 43.5 |
| Fluid 2 (700 cSt) | 3.4 |
| Fluid 3 (300 cSt) | 5.1 |
| Brij 35L | 7.5 |
| Brij 30 | 2.5 |
| Water | 6.5 |
| | 100 |

The resulting particle size is D(v, 0.5)=0.774, D(v, 0.9)=1.14 μm. Variations in the weight percent of the components, the order and placement of each raw material addition and the RPM of the extruder screw enables changes in the particle size. For formulation adjustments in the range of those shown in the table below under various process conditions, the particle size minimum is D(v, 0.5)=0.28 μm, D(v, 0.9)=0.52 um and maximum is D(v, 0.5)=1.6 μm, D(v, 0.9)=3.1 μm.

| | Minimum | Maximum |
|---|---|---|
| Materials | % | % |
| Si Gum | 30 | 33 |
| Fluid 1 (2000 cSt) | 41 | 46 |
| Fluid 2 (700 cSt) | 3.3 | 3.6 |
| Fluid 3 (300 cSt) | 4.8 | 5.3 |
| Brij 35L | 7.1 | 7.8 |
| Brij 30 | 2.3 | 2.8 |
| Water | 2.7 | 10.4 |

After formation of this thick phase emulsion, additional products may be added to the product such as dilution water, preservative, thickener, pH adjustment and additional surfactants.

### Example 6

### Emulsification of a Silicone Gum

A hydroxy-terminated dimethyl siloxane gum of plasticity 55-65 mils, 2 nonionic surfactants and water were fed into the extruder in the ratios shown in the table below.

| Material | % |
|---|---|
| Si Gum | 85 |
| Brij 35L | 11 |
| Brij 30 | 0 |
| Water | 4 |
| | 100 |

The resulting particle size is D(v, 0.5)=3.7 μm, D(v, 0.9)=5.9 μm. Variations in the weight percent of the components, the order and placement of each raw material addition and the RPM of the extruder screw enables changes in the particle size. For formulation adjustments in the range of those shown in the table below under various process conditions, the particle size minimum is D(v, 0.5)=3.7 μm, D(v, 0.9)=5.9 μm and maximum is D(v, 0.5)=70 μm, D(v, 0.9)=150 μm.

| | Minimum | Maximum |
|---|---|---|
| Materials | % | % |
| Si Gum | 74 | 87 |
| Brij 35L | 9 | 11 |
| Brij 30 | 0 | 13 |
| Water | 2 | 7 |

After formation of this thick phase emulsion, additional products may be added to the product such as dilution water, preservative, thickener, pH adjustment and additional surfactants.

1. A method of making a silicone-in-water emulsion comprising the steps of:
(i) forming a hydrophobic phase containing a silicone component selected from a silicone fluid, silicone gum, a silicone rubber, a silicone elastomer, a silicone resin, or a mixture thereof; the silicone in the hydrophobic phase having a viscosity of at least 1,000 mm²/s to 5,000,000,000 mm²/s at 23° C.;
(ii) mixing one or more surfactants with the hydrophobic phase;
(iii) adding water to the hydrophobic phase, the water being added in an amount of 0.5-10 percent by weight based on the weight of the hydrophobic phase;
(iv) shearing the mixture in a twin-screw extruder having a length to diameter (L/D) ratio of at least 12 to form a silicone-in-water emulsion; and
(v) optionally, diluting the silicone-in-water emulsion by the addition of water;
the method being carried out in the absence of a solvent other than solvents present in the silicone fluid, silicone gum, silicone rubber, silicone elastomer, or silicone resin in (i).

2. The method of claim 1 wherein the silicone component is a polydimethylsiloxane fluid.

3. The method of claim 1 wherein the silicone component is a mixture of a polydimethylsiloxane fluid and a silicone gum.

4. The method of claim 1 wherein the silicone component contains an aminofunctional siloxane.

5. The method of claim 1 wherein the surfactant is a polyoxyethylene fatty alcohol or a mixture of polyoxyethylene fatty alcohols.

6. The method of claim 1 wherein the twin-screw extruder has an L/D ratio of 12-60.
